(19) United States
(12) Patent Application Publication
(10) Pub. No.: US 2007/0107355 A1
(43) Pub. Date: May 17, 2007

(54) Window shroud system

(76) Inventor: Phillip R. Campbell, Maumelle, AR (US)

Correspondence Address: Stephen D. Carver, 2024 Arkansas Valley Drive, # 800, Little Rock, AR, 72212-4147, US

(21) Appl. No.: 11/649,107

(22) Filed: Jan. 3, 2007

Related U.S. Application Data
(63) Continuation-in-part of application No. 10/899,940, filed on Jul. 28, 2004.
Application No. 10/899,940 is a continuation-in-part of application No. 10/719,256, filed on Nov. 24, 2003, now Pat. No. 6,865,850.

(51) Int. Cl. E04B 1/62; B27K 1/00

(52) U.S. Cl. 52/515

(57) ABSTRACT

A shroud and construction methods using the shroud wherein windows are temporarily covered for protection. A shroud subframe comprising resilient, plastic extrusions is custom fitted about the window periphery. Each extrusion has an elongated foot, an offset body portion, and an integral ramp connecting the body and the foot. Each extrusion has a peel-away adhesive strip formed beneath the foot and atop the body. A translucent sheet of plastic is adhesively mounted on the subframe face. A region of overlap occurs between adjacent portions of the shroud subframe, and the pieces are adhesively fixed to one another. During subsequent construction steps, shroud foot portions are permanently sandwiched between dry wall segments and window structure. When construction is completed, the exposed junction between the subframe and adjacent sheet rock is cut and discarded, and the sheet is removed.

### CROSS REFERENCE TO RELATED APPLICATION

This application is a continuation-in-part of my previously filed, copending U.S. application entitled “Rolled Window And Fixture Shroud System,” Ser. No. 10/899,940, Filed Jul. 28, 2004, which is a Continuation-in-Part of Ser. No. 10/719,256, filed Nov. 24, 2003, and entitled “Temporary Protective Shrouds For Protecting Windows And Fixtures During Construction,” which issued as U.S. Pat. No. 6,865,850 on Mar. 15, 2005.

### BACKGROUND OF THE INVENTION

1. Field of the Invention

The present invention relates generally to a shroud system for masking various items during construction to prevent paint, debris and the like from marring or defacing fixtures. More particularly, the invention relates to a masking system for actively shrouding window assemblies, bathroom fixtures, or other prefabricated modules installed during construction or remodeling with predefined extruded plastic elements that are adapted to be taped into place.

2. Description of the Related Art

The modern building boom has been stimulated by a variety of factors, the most important one of which appears to be current low interest rates. During the last decade, sales of new residential units have approached or exceeded record levels almost every year. While the increased demand for housing has stimulated the residential construction industry, increasing jobs, profits and general activity in the area, time constraints placed upon the typical contractor have become burdensome. There is a constant rush to finish the job, as buyers are anxious to occupy new dwellings as soon as practicable. The construction boom has also created a skilled labor shortage, and in some areas, shortages of raw materials. As a result, construction costs have increased. At the same time, profit margins are constantly under threat. Successful contactors must work quickly and efficiently under constant pressure, while at the same time maintaining above-average quality control.

Partially because of the foregoing considerations, the use of various forms of pre-fabricated modules has become the norm in modern construction. For example, numerous bathroom and kitchen fixtures or modules exist. The trend is for units to be prefabricated as much as possible by the manufacturer, and to avoid the necessity of finishing or painting or coating these fixtures once installed. Modern bath and shower modules, for example, comprise upright, fiberglass units that need merely be placed upon subframes and then plumbed adequately for use. Windows of varying sizes and configurations are sold as separate, largely aluminum “fin frame” units that are quickly fitted to pre-configured, wooden sub-frames crafted by the carpenter at the job site and nailed into place. A variety of single-hung and double-hung sash windows are available in numerous sizes, styles and configurations. The use of fixtures and increased modularization in general enhance the contractors' speed and efficiency. At the same time, certain quality control problems have been aggravated.

Windows, bathroom fixtures and other modular items are installed midway through the construction process. Fin frame windows are nailed into place, and afterwards they are secured in place within the subframe by dry walling. During dry wall installation, numerous finishing steps are completed. Trimming and fitting steps generate significant dust and debris. The finishing steps include the application of tape, drywall “mud,” and sanding steps for smoothing. Wet mud can spill onto adjacent, unprotected fixtures or windows. Dust generated during sanding can quickly accumulate on exposed surfaces and structures. Hand tools required for the process may be inadvertently dropped onto exposed items, and surface marring or structural damage is not uncommon. Numerous other construction processes that follow add to the mess. For example, spackled ceiling finishing can result in the widespread broadcasting of spackling compound. Unprotected fixtures and windows will require vigorous cleaning before the house can be sold.

Compounding the foregoing problems is that workers often stand or lean upon fixtures during construction. Unshielded contact with hand tools, such as those held in worker's belts, or the application of force and weight prior to the completion of installation can cause damage. Dirty footprints can accumulate and add to the mess. Anything left unprotected is further subject to attack during painting. Drops of dried paint are difficult and time consuming to remove during cleanup.

Cleanup procedures following interior construction steps are intended to remove dust, debris and grime. However, it can be very difficult to remove paint stains from some devices, and it is virtually impossible to remove substantial surface blemishes caused by abrasion or impact with falling tools or equipment. Sometimes expensive shower or bathroom modules are inadvertently damaged by inappropriate worker short cuts, exemplified for example, by the common practice of temporarily placing hand tools and/or paint cans within shower stalls or upon window ledges. Sometimes even rigorous cleaning efforts cannot adequately cure surface blemishes or damage, and fixture replacement is necessitated.

The prior art has recognized the general problems outlined above. Diverse paint and masking devices that temporarily cover various interior surfaces are known. Protective drop cloths are commonly deployed to prevent damage to objects in work areas. Large drop cloths deployed from rolls may be used on walkways, patios, decks, and carpeted areas. Standard drop cloths afford reasonable protection, but they have certain disadvantages. For example, cotton drop cloths are not impermeable to certain fluids, so oil-based paint can pass through and deface the covered surface.

Window fixtures can be masked by paper or plastic sheeting secured to the frame periphery by adhesive tape. However, such conventional masking methods are inefficient. Substantial labor must be invested during both installation and subsequent removal. In the past, individual sashes have been covered by temporary plastic panels, which must be installed and then removed in separate time-consuming steps.

U.S. Pat. No. 2,934,392 shows an early, well-known window masking method.

U.S. Pat. No. 3,837,949 shows a protective masking system for windows wherein strips of sheet covering are unwound from a large reel and applied over the surfaces to be protected.

U.S. Pat. No. 4,398,495 issued Aug. 16, 1983 discloses a thin, sheet-like paint shield comprising intersecting longitudinal and transverse creases. The crease arrangement enables the shield to be conformed about irregular volumes such as corner moldings or the like. By flexing the shield about its longitudinal crease, the bent portion automatically snaps back into a coplanar relationship with the remaining portion of the sheet so that its maximum longitudinal length is again available for shielding while painting.

U.S. Pat. No. 4,263,355 issued Apr. 21, 1981 sets forth a paint shield for masking a carpet or floor edges. The paint shield is formed from sections of a flat strip of resilient material packaged in a roll. The strip is rolled flat and springs back to shape when unwound from the roll.

U.S. Pat. No. 4,510,986 issued Apr. 16, 1985 shows a shrouding system wherein magnetic tape strips are used to temporality attach a shroud around the entirety of a window.

U.S. Pat. No. 4,921,028 issued May 1, 1990 discloses a door hardware cover that can protect knobs and locks. A plastic sheet is adhesively attached to the base of the door hardware.

U.S. Pat. No. 5,042,656 issued Aug. 27, 1991 provides a door-shield in the form of a disposable envelope that functions as a protective sheath. The door to be protected is in effect sandwiched between its sides. The envelopes are formed as large plastic and paper sheaths are pulled onto the edge of a door opposite the door edge hinged to the frame. Once painting or decorating is complete, the envelopes are removed and discarded.

U.S. Pat. No. 5,058,340 issued Oct. 34, 1991 discloses a plastic film sheet and mounting method for shrouding large planar areas like ceilings. A plastic edge connector ultrasonically welded about the periphery of the region being protected grasps edges of the shroud. Heat is applied to tightly stretch the shroud into the desired position.

U.S. Pat. No. 5,103,593 issued Apr. 14, 1992 discloses a door shield for temporarily covering a door during construction. A polymeric rear layer mounts an accordion-pleated forward surface formed of parallel ribs to provide impact resistance. Magnetic and adhesive members are coextensively formed at a rear perimeter of the door for adherence of the structure to the door.

U.S. Pat. No. 5,107,643 discloses a system for protecting glass in windows and doors during construction. However, no means are provided for covering the window frame, such as the metallic frame periphery of a typical fin frame window, during original installation.

U.S. Pat. No. 5,230,738 issued Jul. 27, 1993 discloses a pliable masking device for covering a targeted area during construction activities.

U.S. Pat. No. 5,266,390 issued Nov. 30, 1993 discloses a plastic dropcloth comprising a layer of polypropylene film bonded to an intermediate layer comprising either polyethylene or polypropylene film. The polypropylene film absorbs and resists hydrocarbon liquids such as paint, wood stains, paint thinners, solvents and the like. In manufacture, the layers are fusion bonded together via heating units and pressure rollers

U.S. Pat. No. 5,330,814 issued Jul. 19, 1994 describes a protective cover pad having a backing sheet with a layer of adhesive and a removable strip of a flexible foam material, which is peelable from the adhesive surface. The strip of foam-like material has a greater thickness than the backing sheet and a greater width than either of the side portions of the backing sheet.

U.S. Pat. No. 5,441,769 issued Aug. 15, 1995 discloses a paint mask for shielding windows while painting the mullions disposed between adjacent panes. Each mask is made of flexible, plastic sheeting, and is sized to cover an individual pane of glass.

U.S. Pat. No. 5,468,538 issued Nov. 21, 1995 discloses a paint masking kit for windows and a method for masking windows. The kit comprises a plurality of reusable covers for shrouding a window periphery and plastic sheet material. The kit is applied to a window that is already installed, and no provision for mounting the system to a window that is being installed during original construction has been contemplated.

U.S. Pat. No. 5,658,632 issued Aug. 19, 1997 discloses a masking strip equipped with adhesive for affixation to various structures. The mask is first placed over an area to be protected, and a desired portion of the adhesive patch is peeled back to enable custom affixation.

U.S. Pat. No. 5,816,305 issued Oct. 6, 1998 discloses a method for protecting an object during application of a fluid onto a surface, and a drop cloth having a first layer made of non-woven fabric material and a second layer of plastic.

U.S. Pat. No. 5,921,282 issued Jul. 13, 1999 discloses a disposable protective cover for exposed plumbing fixtures.

U.S. Pat. No. 6,141,921 issued Nov. 7, 2000 provides a sheet-like weather barrier for windows and doors. Double-faced tape bonds a sheet to a window frame. A stiffening band strengthens the sheet. Means are provided to minimize stretching and avoid the necessity of measuring. However, there are no analogous extruded frame pieces disclosed or utilized. Further, the structure fails to provide a solution for protecting fixtures during initial construction.

U.S. Pat. No. 6,143,392 issued Nov. 7, 2000 discloses a drop cloth especially configured for railings and banisters. An elongated, protective cover is fabricated from a strip of plastic or treated canvas.

U.S. Pat. No. 6,165,269 issued Dec. 26, 2000 presents a kit for masking door and room hardware during painting. A variety of masks are configured for specific pieces of hardware, such as door hinges, door knobs, dead bolts, wall outlets and electric switches. A tapered cross section portion of each mask creates a fine edge that closely fits into the joint between the hardware and the door or wall.

As recognized in my U.S. Pat. No. 6,865,850 issued Mar. 15, 2005, a low-maintenance, temporary protective shroud for windows and other construction fixtures, that may be easily deployed and then removed by the contractor when either interior or exterior construction is completed, is highly desirable. An adequate shroud must be light-weight, protective, durable, tear-resistant, and liquid-proof. It must not interfere with normal construction. Preferably, the system must be adapted to quickly fit a variety of dimensions and sizes. Furthermore, quick adjustments to shroud size must be possible at the job site without time-consuming measuring and cutting. Once interior construction or remodeling is complete, the shroud must be removable as fast as possible.

One disadvantage with rolled systems is the lack of rigidity. Recently I have realized that all of the foregoing goals can be best achieved through a masking system involving cooperating, pre-sized, extruded pieces that are strong or rigid enough to hold their shape as they are applied about the framework at the job site. I have determined that a system involving resilient flexible extrusions that can quickly be applied to the framework periphery, and that will not change their shape or droop or fold during installation, is ideal.

Furthermore, while sheet portions of flexible plastic are necessary to cover the bulk of the window area (i.e., at the middle between frame portions), once the extrusions are properly installed, an unobstructed sticky adhesive surface can be exposed by peeling away peel strips, and the plastic sheets may easily be installed without worrying about folding, bending or drooping.

Another important problem with prior art window shrouding systems is that the must be removed or partially destroyed when it is necessary to open a window. During indoor construction, for example, partially-completed houses will lack air conditioning, and in the summer months some ventilation will be necessary because of the heat. Many construction workers smoke, and ventilation will be necessary in smoking areas. Thus, an adequate shrouding system installed over unfinished fin frame windows must enable construction workers to raise the window at least part way to allow ventilation. Window manipulation must be possible without removing or destroying or damaging the protective shroud system.

### BRIEF SUMMARY OF THE INVENTION

This invention provides a masking or shrouding system for original window construction. The method can be used to effectively shroud fixtures, such as window assemblies, bathroom fixtures, shower modules, and other prefabricated fixtures, during various construction stages. The apparatus comprises a special extrusion that fits within the confines of fin frame windows and the like, and is secured after resultant construction, to form a mounting frame for subsequently applied sheets of covering plastic that protect the window.

During those facets of construction likely to raise and distribute dust and debris, any object upon which one of my shrouds has been deployed is isolated and protected from dust, debris, and inadvertent injury. Not only is cleanliness maintained, but damages from contact with humans or tools or spilled liquids like paint, dry wall mud, or the like is avoided. After the various construction steps are substantially completed, the shroud can be quickly and easily removed by cutting. Thereafter, the shroud and its extruded supports are cut or torn away and discarded. After caulking, no visible trace of the shroud or its supporting extrusions is left.

The preferred shroud material comprises plastic sheet material of acrylic plastic. Alternatively, polypropylene or polyethylene sheet may be used.

The preferred shroud is custom installed at the job site by first fitting sections of special shroud extrusion. The translucent extrusion is preferably made from acrylic, polypropylene or polyethylene plastic. The extruded stock material is cut into sections of appropriate length at the job site. Since the pieces fit or nest together, needed lengths are merely approximated, because length adjustments are possible merely by axially adjusting the pieces. For example, to cover a window, one or more elongated sections are cut for the sides, and they can be mated together and slidably adjusted to the right length. Shorter sections can be similarly manipulated for the top and bottom of the window structure.

Preferably, the stock material, and each shroud piece that is cut from the stock material, comprises a flat foot portion, a flat and spaced-apart body portion, and an adjoining middle portion connecting the foot and body portions. Preferably the stock materiel used for interior construction has a ramp-like middle portion that provides an offset. The ramp portion positions the body portion away from the lower foot portion, while maintaining them parallel. The outer edge of the foot portion and the body portion terminate in elongated lips that reinforce the structure and help align the panel pieces upon installation.

Numerous adhesive peel strips are defined beneath the extrusions to ease construction. After the elongated, adhesive peel strips beneath the foot portions of a given extrusion are removed, the piece may be attached to a window, for example, by adhesively affixing the foot portion to an exposed peripheral window surface. As the outer peripheral frame of the exposed window is covered top and bottom by extrusion pieces, the adhesive strips can fasten upper and lower horizontal extrusion pieces upon the vertical extrusion pieces installed first at the window sides. The affixed extrusion pieces form a mounting frame for receiving the plastic sheet that covers the window.

Adhesive strips are also affixed upon the exposed outer surface of the extrusions. Once the extrusions are fitted, the outer removable strips can be quickly peeled away, leaving an adhesive point of attachment for the plastic sheet material cut and attached in the form of a rectangular sheet. Alternative, exposed outer adhesive strips can mount or brace an overlying shroud piece.

Edges of the covering sheet are pressed against exposed adhesive patches to mount the sheet over the mounting frame. Once mounted in this fashion, either internally or externally, construction may progress and debris will be prevented from contacting the window. The waterproof sheet is preferably translucent. The sheet material is preferably acrylic plastic, but it may be made from polyethylene, polypropylene or other translucent polymer plastic materials.

Once installed internally, dry walling commences, and edge portions of the resultant mounting frame (i.e., edges of the extrusions) are thereby captivated and sandwiched permanently against portions of the window peripheral frame and adjoining dry wall segments. Afterwards, finishing steps may follow. For example, tape and mud may be applied, and sanding, painting, and other miscellaneous finishing tasks may be completed. The exposed peripheral junction between the resultant multi-piece shroud foot portion and the adjacent sheet rock may be cut. The cut extrusion portions and the shroud formerly supported thereby may then be torn away, removed, and discarded. The junction is then caulked for cosmetic effects along the cutting line. A clean, undamaged and unmarred fixture remains. Alternatively, the shroud may be formed from numerous sheets (i.e., in excess of two) to cover larger areas.

Thus, a basic object of my invention is to provide a low cost method for shrouding windows interiorly or exteriorly, from dust, debris, overspray, and miscellaneous dirt and debris during original construction.

Another basic object is to protect exposed surfaces of windows from debris and damages that might occur during construction.

A related object is to isolate windows from damages that might result from contact with workers, or miscellaneous construction tools used during construction.

It is also an object of the present invention to provide a new and useful method for protecting windows from construction fluids or substances including paint and other compounds or mixtures comprising hydrocarbon solvents.

Moreover, it is an important object of my invention to provide suitable extrusions for forming a semi-permanently affixed mounting frame that ultimately supports a shroud of sheet material over a window.

It is still another object of the present invention to provide a protective shroud system for windows that may be easily adjusted during installation to snugly fit a variety of sizes, shapes and configurations.

Another important object of my method and apparatus is to provide a protective shroud system for windows of the character described that temporarily enables ventilation then desired. It is a feature of my invention that the shroud need not be completely removed to open a window at least part way for ventilation when necessary.

A related object of this invention is to provide a protective shroud system of the character described that may be quickly and easily removed once construction is substantially finished.

Yet another object is to provide a highly durable shroud of the character described that is lightweight, puncture-resistant, and rapidly deployable over standard fin-frame windows of a variety of sizes and configurations.

Another object is to provide a shrouding method of the character described that is not only ideal for indoor use, but is adapted for outside use to protect windows from over-spray during painting, from mortar during brick-laying activities, or other dirt and debris.

A related object of my invention is to provide a customizable shrouding process that readily adapts for use with windows of different dimensions and configurations, either inside or outside a building.

Another important object is to enable the installer to accommodate different heights and widths of windows without time-consuming measuring or cutting steps. It is a feature of my invention that a pair of extrusions can be coupled together and rapidly axially adjusted as necessary to fit a variety of differently sized applications.

A major object is to provide a protective shroud system of the character described that, once removed from the window, is invisible, and leaves no trace of its former presence.

These and other objects and advantages of the present invention, along with features of novelty appurtenant thereto, will appear or become apparent in the course of the following descriptive sections.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 is a partially exploded, fragmentary isometric and pictorial view showing my interior shroud system being deployed within a building adjacent a conventional double sash, fin-frame window;

FIG. 2 is a fragmentary, exploded isometric view of the exposed periphery of a fin-frame window shown installed in FIG. 1, showing a portion of my shroud extrusion that is fitted vertically to the window edge;

FIG. 3 is a fragmentary, exploded isometric view similar to FIG. 2, showing an additional portion of shroud extrusion that is to be fitted horizontally over the top of the window edge and the previously installed vertical portion;

FIG. 4 is a fragmentary, exploded isometric view similar to FIGS. 2 and 3, showing how the horizontal and vertical portions of the preferred shroud extrusions shown in FIGS. 2 and 3 fit together at corner regions;

FIG. 5 is an enlarged cross sectional view showing the best mode of my interior shroud extrusions, taken across lines 5-5 in FIG. 1;

FIGS. 6-10 are fragmentary, isometric and diagrammatic views showing the sequential application of my shroud system and succeeding construction materials or steps preferably used inside a building or dwelling;

FIG. 11 is a diagrammatic view of the final stage of shroud system use, showing the removal of exposed extrusion portions;

FIG. 12 is a fragmentary, isometric view of the exterior of a fin-frame window that has been protected with my exterior shroud extrusions, with the final plastic covering sheet omitted;

FIG. 13 is an enlarged, fragmentary isometric view of circled region 13 in FIG. 12;

FIG. 14 is an enlarged cross sectional view showing the best mode of my exterior shroud extrusions, taken generally across lines 14-14 in FIG. 13;

FIG. 15 is an enlarged, fragmentary, isometric view of the preferred exterior extrusion; and,

FIG. 16 is a fragmentary, diagrammatic view showing an example of exterior construction, with pieces omitted for brevity or broken away or shown in section for clarity.

### DETAILED DESCRIPTION OF THE INVENTION

The present shroud system is an improvement and modification of my prior shrouding inventions which are the subject of my U.S. application entitled “Rolled Window And Fixture Shroud System,” Ser. No. 10/899,940, Filed Jul. 28, 2004, and my U.S. Pat. No. 6,865,850 issued Mar. 15, 2005 that is entitled “Temporary Protective Shrouds For Protecting Windows And Fixtures During Construction. For purposes of disclosure, the entire specification of these references is hereby incorporated by reference.

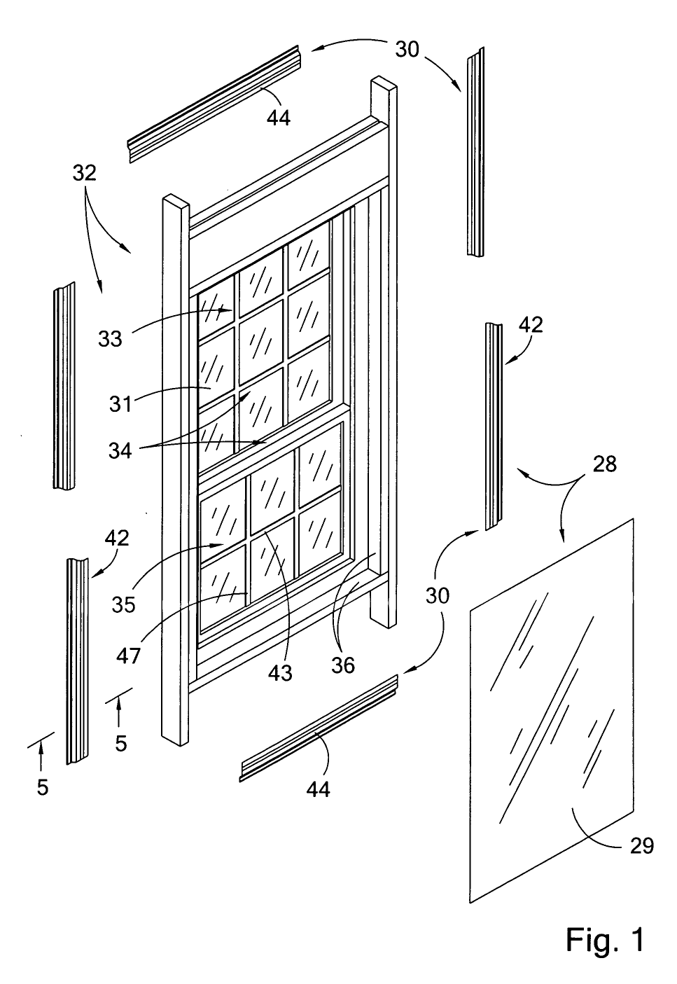

With initial reference directed to FIG. 1 of the appended drawings, a construction fixture, in this instance a prefabricated window assembly 32, is to be shrouded and protected in accordance with the invention during building construction. The window assembly 32 is seen from the inside of the building in FIG. 1. As used herein, the term “construction fixture” refers to a variety of fixtures and/or construction modules or frameworks or items that are commonly installed at job sites, such as kitchen fixtures, prefabricated windows, bathroom fixtures such as shower stalls and bathtubs, and various other prefabricated assemblies. Once my preferred indoor shroud system 28 is properly applied, subsequent construction steps may proceed, with the fixture protected from damage and marring. The shroud system 28 comprises a peripheral subframe 30 that is constructed at the job site and temporarily affixed about the window assembly 32, and a covering sheet 29 of plastic that overlies the window and is supported by the subframe 30.

Once a prefabricated window assembly 32 is protected as. described hereinafter, dry-wall construction and various ancillary and secondary construction steps may proceed non-destructively, during which time the window is protected from dirt and debris either inside or outside the building. According to the preferred method, a shroud subframe 30, comprising a plurality of properly cut and interfitted plastic panels 42, 44 is installed, and then a transparent sheet 29 is affixed to the shroud subframe 30. Drywalling and other normal construction steps known in the art may proceed. After interior construction is substantially completed, the shroud system 28 is quickly removed and discarded, by tearing away the sheet 29 and cutting the exposed portions of shroud subframe 30 (i.e., the panels) as described hereinafter. This reveals a clean and undamaged fixture that does not require tedious and time-consuming cleaning.

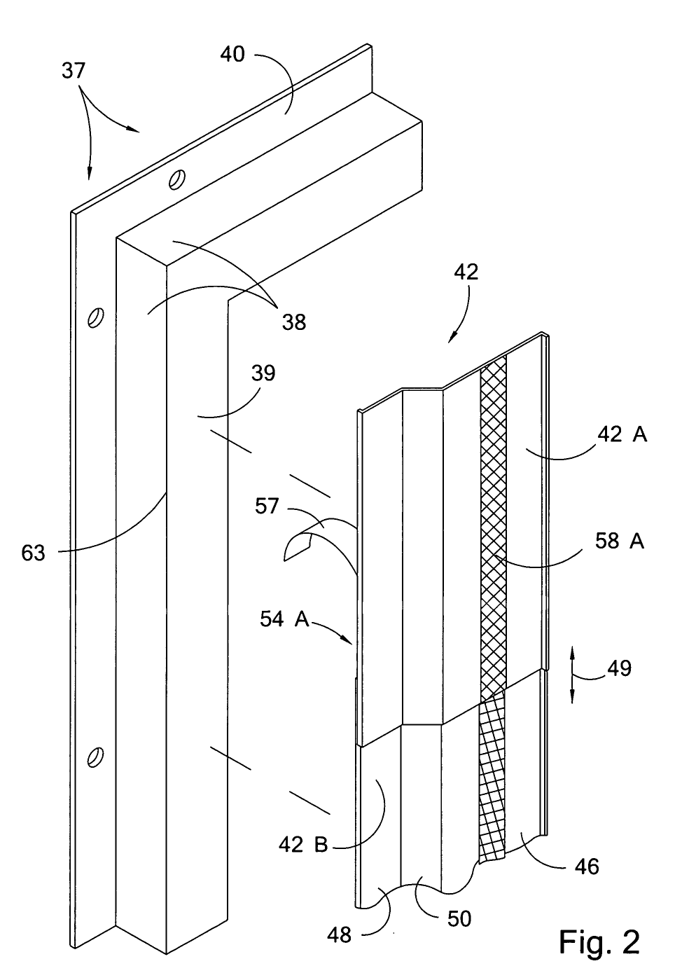

Window assembly 32 (FIGS. 1, 2) comprises a conventional, dual-sash, fin frame window 34 that is received by and nested within a generally rectangular, window enclosure 36 built into the substantially wooden framework of the building. Window 34 is formed from extruded aluminum pieces in a number of well-known configurations in varying sizes and aspect ratios, and the invention is not limited to any particular window design such as dual sash or fm frame designs. Normally each window sash 33, 35 has a plurality of individual glass panes 31 disposed between alternate vertical mullions 47 and horizontal mullions 43 (FIG. 1). Of course it should be recognized that single pane sashes exist as well. A thin, peripheral “fin” 40 with mounting orifices 41 is disposed at and around the exterior side of the prefabricated window 34 (FIG. 2). This construction provides a stepped or notched structural profile comprising an offset periphery 37, that enables flush mounting of the window within a suitable recessed receptive region formed by wooden framing, as is known in the art. Periphery 37 has an outer edge comprising a flat, surface portion 38 that is perpendicular to fin 40, and a flat, integral peripheral surface 39 that is offset from and parallel with fm 40. Peripheral surface 38 will be nested against the receptive wooden framing enclosure 36. Window assembly surface 39 and the window glass panes and mullions will be shrouded by system 28.

The shroud subframe 30 is made of several separate panels or pieces of panels that can be custom cut and fitted at the job site. Cut panels that are to be oriented vertically during installation are designated by the reference numeral 42 in FIGS. 1-3. Similarly, cut panels that are to be oriented horizontally after installation in the illustrated example are designated by the reference numeral 44 (FIGS. 1-3). As implied from FIG. 1, numerous cut panel pieces 42, 44 are adhesively pressed up and against periphery surface 39 to form and mount the subframe 30. FIG. 1 also shows a generally rectangular auxiliary covering sheet 29 that affixed over the window once the shroud elements are affixed, which will be described hereinafter.

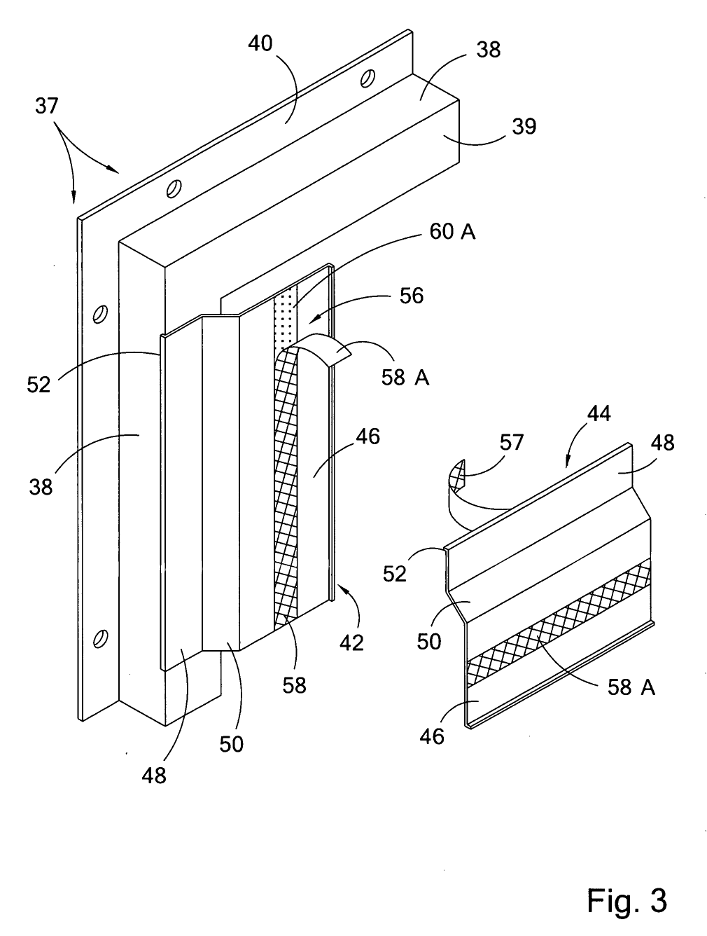

As best seen in FIGS. 2, 3 and 5, panels or panel pieces 42 and 44 are all cut from the same elongated, stock of plastic material. Preferably the panel stock for the subframe 30 is made by extruding plastic, but it is contemplated that suitable panels may be made from blow-molded or even injection molded plastic stock. As best discerned from FIG. 3, a given length of subframe can be formed from two overlapping pieces 42A and 42B. When cut, overlapping pieces such as 42A and 42B can be slidably axially adjusted relative to one another as indicated by arrow 49. By moving the pieces either to extend or contract the resultant length, the composite panel 42 applied to the left side of the window (i.e., as viewed in FIG. 1) can be formed in virtually the exact length required without tedious measuring or cutting. Portion 42A will be placed atop portion 42B overlying it, so moisture, for example, dripping downwardly will be guided away from the window components. As detailed hereinafter, portions 42B can be quickly fitted over portion 42B by removing the peel strip 57 (FIG. 2) to expose an adhesive strip that allows the individual extrusion pieces to be press fitted together.

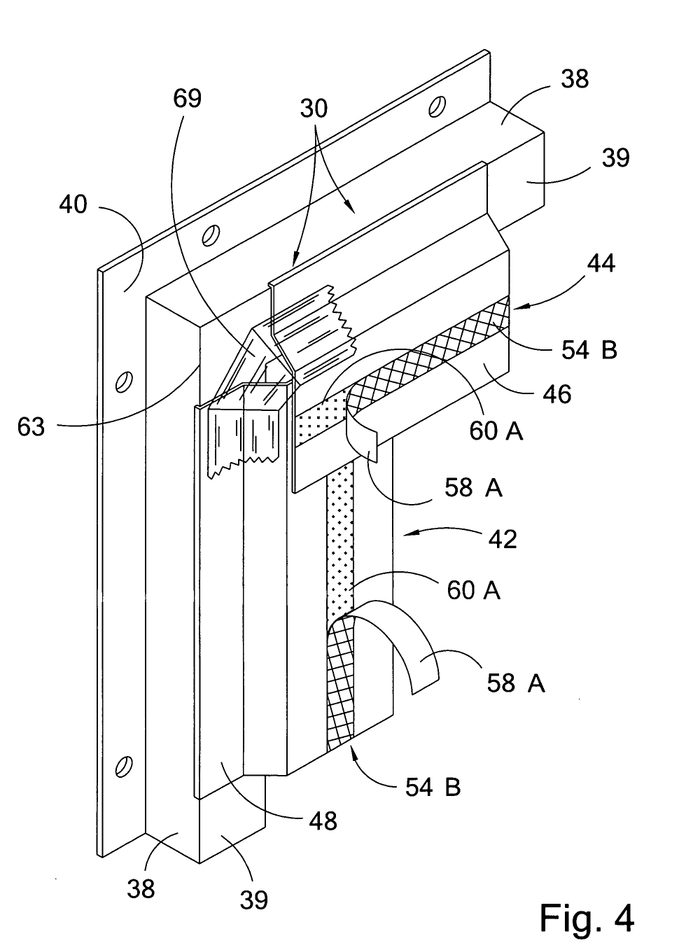

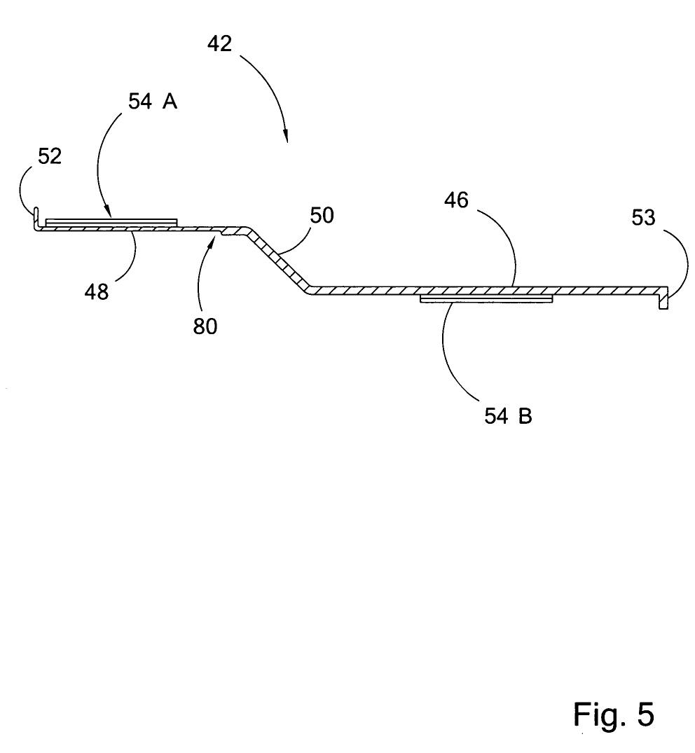

Preferably each panel (and thus each subframe piece) is extruded. There is an elongated, flat body portion 46 that is integral with a spaced apart foot portion 48. Portions 46 and 48 are joined by an integral, connecting middle portion 50 that effectively offsets body portion 46 from foot portion 48, while maintaining them parallel. Preferably for interior work the middle portion 46 is inclined, forming a ramp. The offset ramp ultimately allows windows to be temporarily opened for ventilation, without removing the system. Body portion 46, foot portion 48, and ramp portion 50 are elongated and integral. The flat, planar body portion 46 is offset and spaced apart from planar foot portion 48, and portions 46 and 48 are generally parallel. In the best mode the outermost edge of the foot portion 48 terminates in a downwardly turned lip 52 that effectively aligns the pieces upon installation by contacting and anchoring against surface 38, upon edge 63, as viewed in FIG. 4. Preferably integral body portion 46 terminates in an upwardly turned lip 53 (i.e., FIG. 5) that helps align overlying pieces.

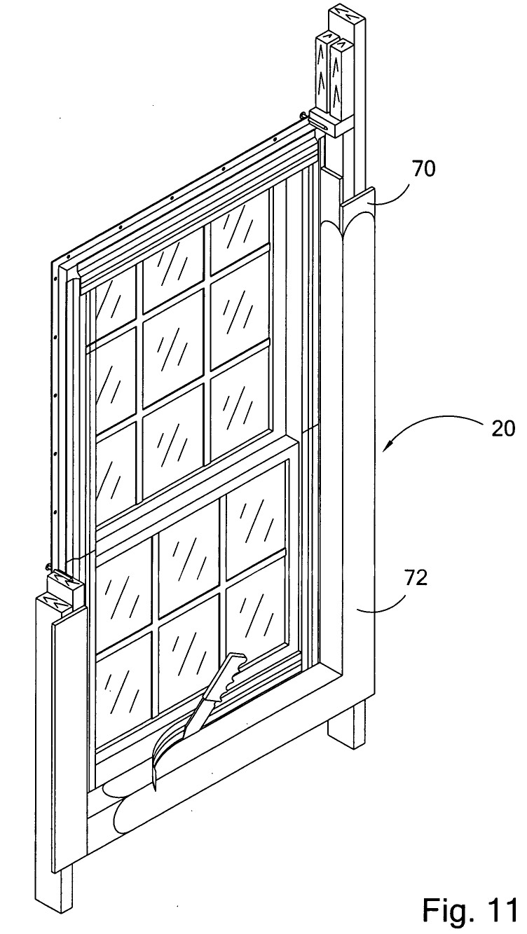

Preferably the panel stock material is water-proof and translucent, comprising acrylic plastic, but it may be made from polyethylene, polypropylene or other translucent polymer plastic materials. The thickness of the shroud body portions 46 and ramp portions 50 is preferably 0.020 inches in the best mode known to me at this time. Foot portion 48 is preferably thinner than the ramp or body portions (i.e., 0.010 inches) in the best mode, to facilitate rapid cutting (i.e., as in FIG. 11) when construction is complete so the shroud subframe can be quickly cut, removed and discarded. The elongated, parallel lips 52 and 53 reinforce the material to insure that panels cut from it are of adequate strength.

As viewed in FIGS. 2 and 4, the subframe pieces are provided with numerous adhesive peel strips for assembly, each of which comprises an adhesive patch temporarily covered by a removable tear strip that can be removed to expose the adhesive. Preferably there are elongated, adhesive strips 54A on the bottom of the panel pieces, i.e., they are disposed beneath the panel foot portions 48 with peel away strips 57 (FIGS. 2, 5). There are similar elongated adhesive strips 54B on the top of the panel pieces, i.e., on the outside of the subframe panel body 46. Each adhesive strip has an internal adhesive patch 60A covered (i.e., before deployment) by the peel strips 57 or 58A (FIG. 2). With the tear-away strips removed the adhesive patch 60A is exposed, so the subframe panel piece may be press fitted against the window fixture periphery and installed. As appreciated from a comparison of FIGS. 2 and 4, the peel strip 57 beneath the foot portion 48 can be removed so that subframe piece 42 may be pressed against and adhesively affixed to surface 39. At this time, when the subframe piece is press-attached to the window frame surface 39, lip 52 will abut and lie coextensively against corner 63 (FIG. 2), which forms the boundary between aluminum surfaces 38, 39.

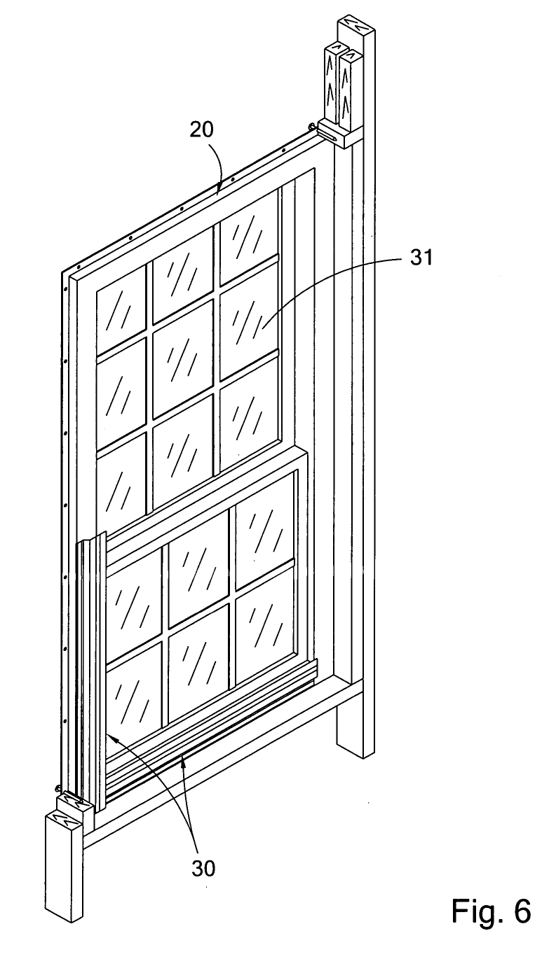

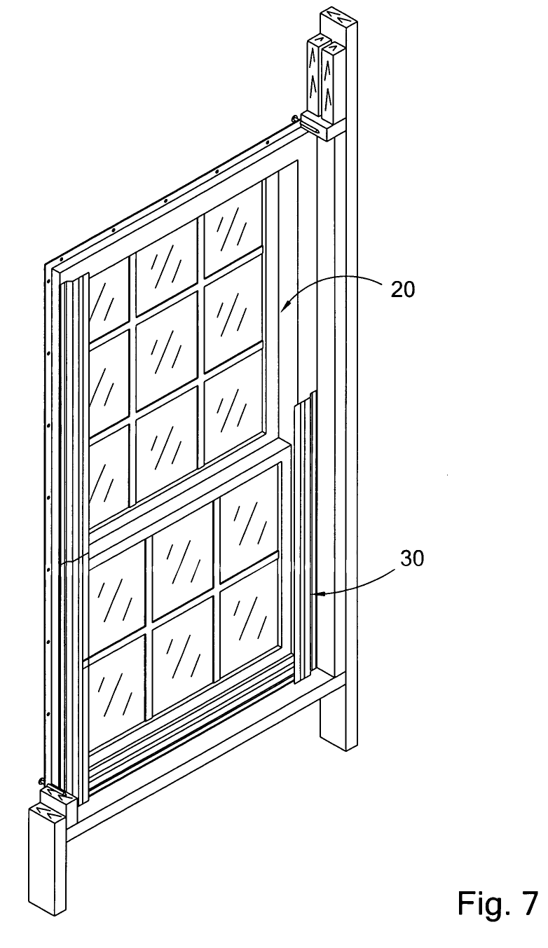

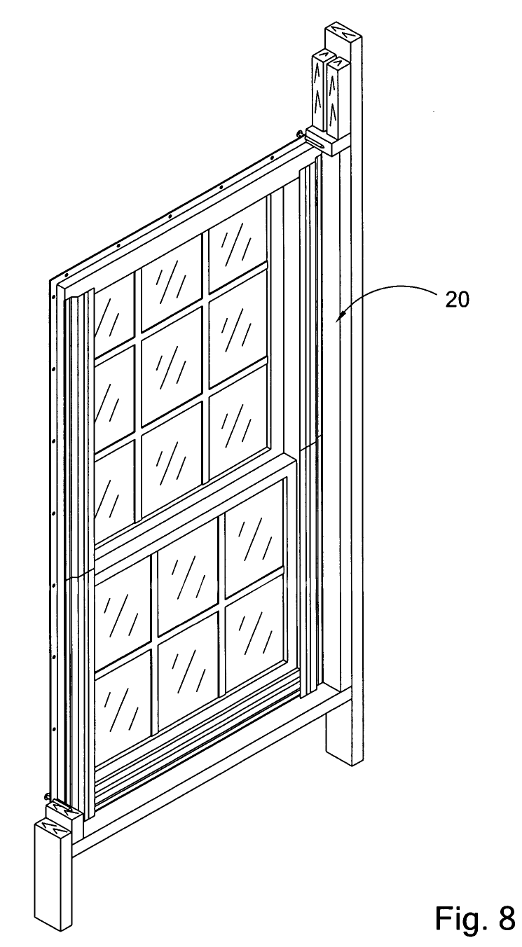

With a vertical subframe panel 42 affixed vertically as in FIG. 3, a horizontal subframe piece 44 is affixed. At this time upper peel strip 58A atop the body 46 of piece 42 is removed, to provide a connection point for the next subframe piece 44. Similarly, the tear strip 57 (FIG. 3) at the underside of the foot portion 48 of shroud piece 44 is removed, exposing an adhesive patch for connection to surface 39. Referring to FIG. 4, it will be seen that a portion of shroud piece 44 overlies the top of piece 42. The underside of the body portion 46 of shroud piece 44 is thus adhesively secured to the outside of the body portion 46 of shroud piece 42 by the exposed adhesive patch designated by the reference numeral 66 (FIG. 4). Construction of the subframe 28 proceeds similarly until panel pieces such as 42, 44 surround the entire periphery of the window assembly 32. Deployment of the resultant, generally rectangular subframe 30 proceeds as illustrated successively in FIGS. 6-9. When the subframe 30 is completed, the generally rectangular, plastic sheet 29 (FIGS. 1, 9, 10) may be deployed.

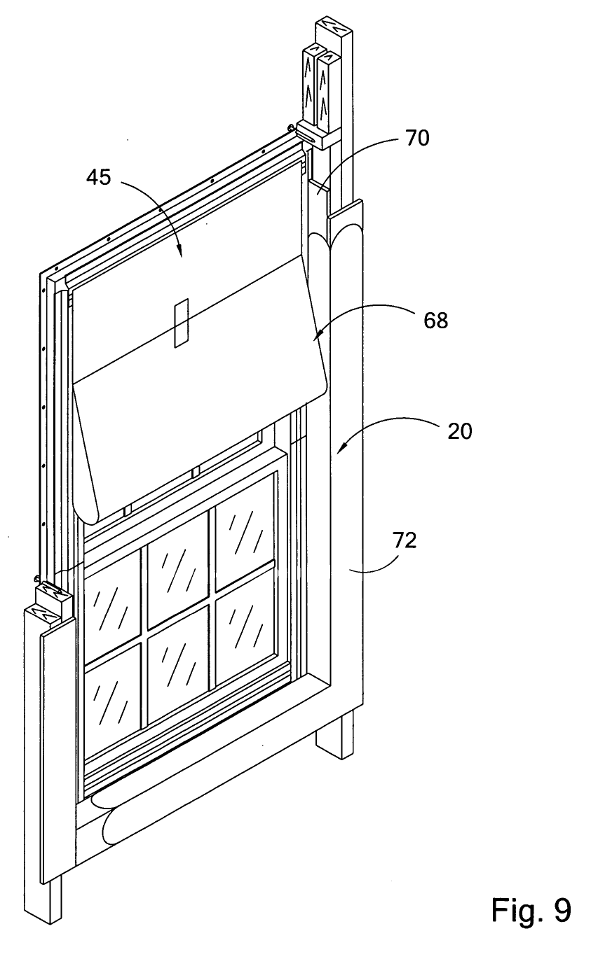

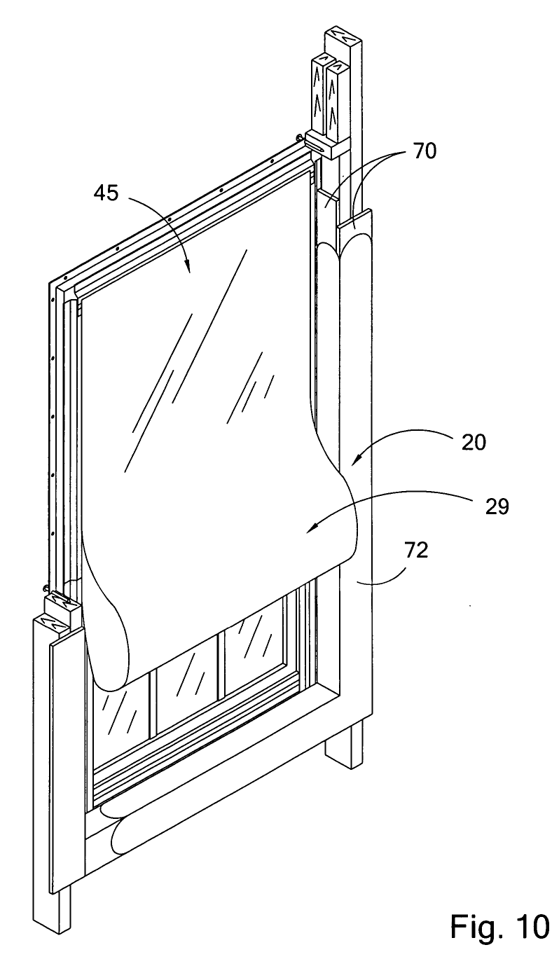

As best seen in FIG. 4, the tear strips 58A on the outer surface of body 46 on each subframe piece may be removed to expose adhesive patches 60A (FIG. 4) that receive and secure a sheet 29. In other words, the edges of sheet 29 may be pressed against exposed adhesive patches 60A to mount the sheet 29 over the window as in FIG. 10. Once mounted in this fashion, either internally or externally, the sheet 29 may be folded up over itself as in FIG. 9. When the sheet is fully deployed as in FIG. 10, its lower portion 68 may be deflected upwardly temporarily, should the covered window be opened. Noting FIG. 4, it is preferred that a small piece 69 of masking tape be applied in the corner region of abutting panels.

Sheet 29 is preferably water-proof and translucent. The sheet material is preferably acrylic plastic, but it may be made from polyethylene, polypropylene or other translucent polymer plastic materials.

FIGS. 6-10 indicate successive steps of shroud installation, whereby the periphery of the window unit is covered by appropriately sized subframe panel pieces 42 or 44. After the protective sheet 29 is installed (FIGS. 9, 10), drywall or sheet rock pieces 70 can be installed, as described in detail in my above cited patent and pending application. The sheet rock is covered by mud and/or taping, generally designated by reference numeral 72 (FIGS. 9, 11) before sanding and then painting. When necessary to expose the glass window panes, the sheet 29 can be curled or folded as in FIG. 10, with its bottom disposed underneath the top of the sheet so that fluids or materials contacting the sheet are directed outwardly rather than inwardly. With finishing completed, the installer removes the exposed piece of the shroud subframe 30 by cutting with a knife 74 (FIG. 11). The lesser thickness of the subframe foot portions 48 enables rapid cutting, substantially at the junction 80 (FIG. 5) where the lower thickness foot portion begins. The foot portions of the subframe pieces will be concealed against the window by the drywall pieces, and cutting progresses to remove the body and ramp portions, which can then be discarded, as in FIG. 11. Afterwards optional caulking, sanding and other finishing and/or painting steps may proceed, as known by those skilled in the art, and remnants of the subframe 30 will be completely concealed.

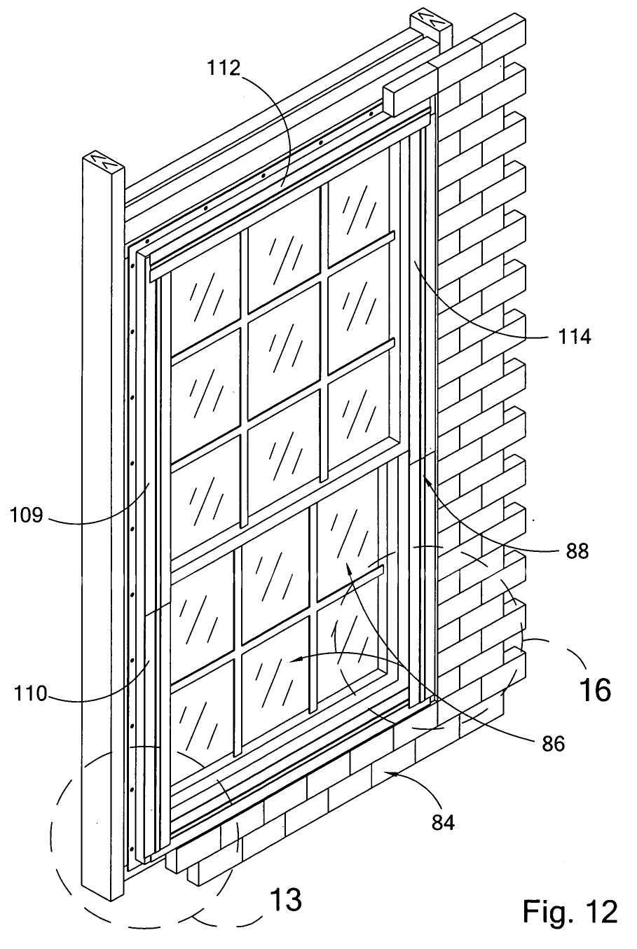

FIGS. 12, 13, and 16 show the window from the outside of the building. During an initial phase of construction portions of the fin frame window will be covered by bricks, insulation panels, or whatever external siding materials are applied, as recognized by those skilled in the art. The brick exterior is represented by the reference numeral 121 , the window has been designated as 86, and the external or outdoor subframe has been generally designated by the reference numeral 88.

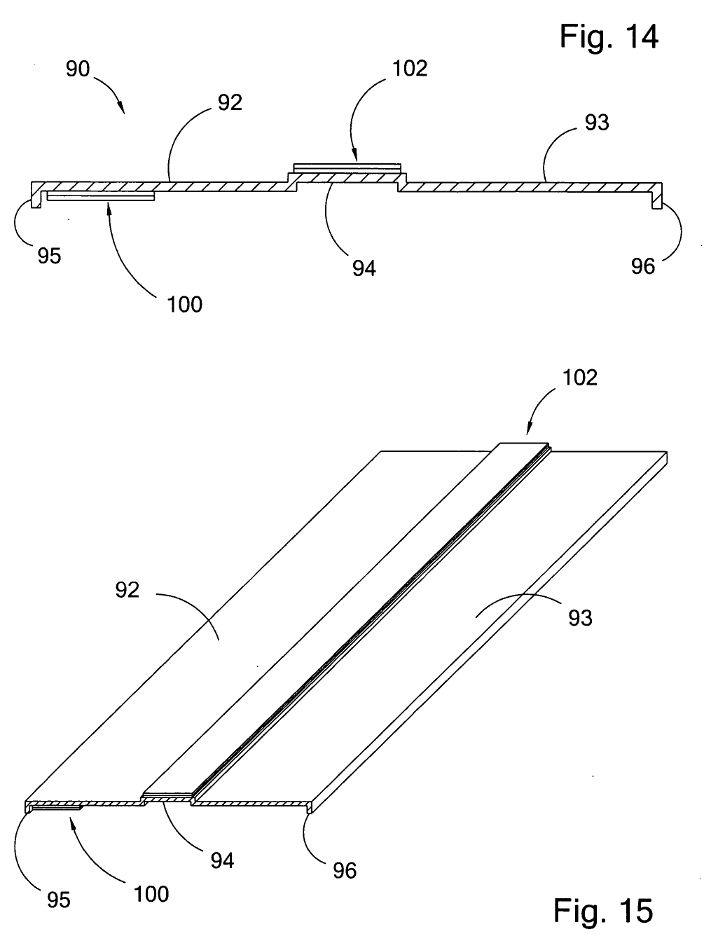

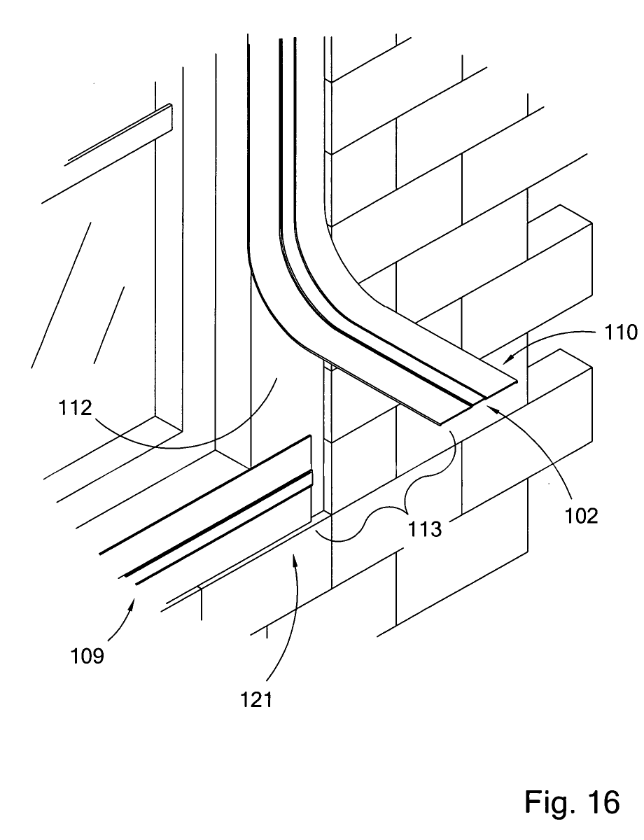

In this instance a different plastic stock is preferably used to make the outdoor subframe panels. Noting FIGS. 14-16, the preferred outdoor stock extrusion 90 has a left foot 92, an integral and coplanar body 93 on its right, and an upwardly offset middle 94. Foot 92 terminates in downwardly turned lip 95, and body 93 terminates in downwardly turned lip 96. A peel-away adhesive strip 100 is disposed on the bottom of the panel pieces, beneath foot 92, as seen in FIG. 14. Another adhesive tear strip 102 is deployed on top of the panel pieces, preferably atop middle 94. Lips 95 and 96 reinforce the structure, along with the opposite raised edges of the offset middle 94. Each tear strip comprises an adhesive layer that is exposed by removing a tear strip.

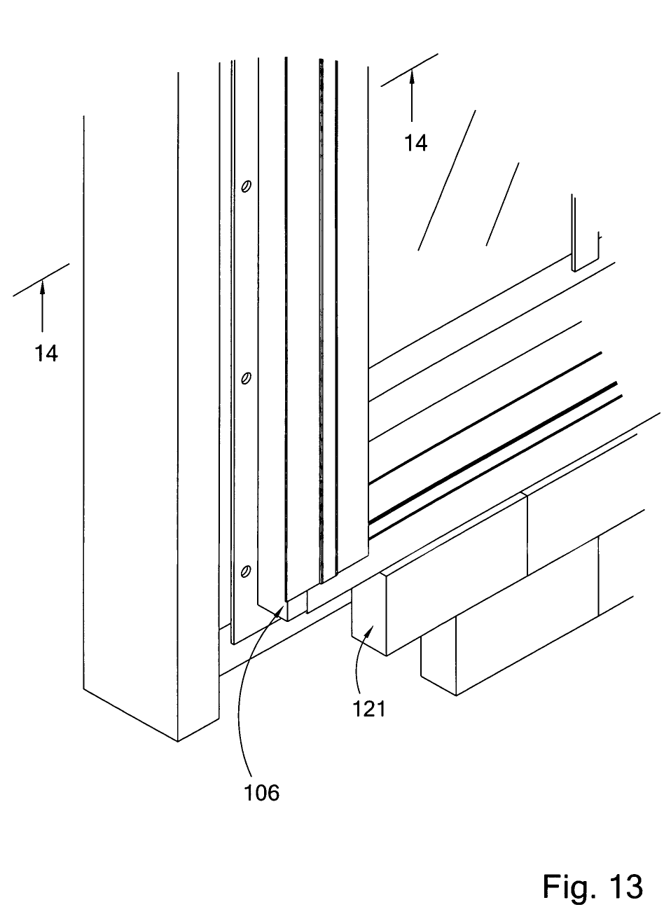

Construction of the outdoor subframe 113 proceeds by cutting and sizing suitable panel pieces 106 (FIG. 13), 109, 110, (FIG. 16) in the manner described previously. Panel feet are affixed to exposed window frame portions 112 and affixed thereto by deploying the adhesive strip 100 in the manner described earlier. Preferably the lower ends of subframe panels 106, 110 overlie the lower horizontally disposed panel 109 so that rain dropping down the surface will be directed outwardly instead of inwardly. When a window subframe 113 is completed, the peel-away strips from tear strips 102 are removed so that an appropriately sized plastic sheet may be deployed over the outside of window 86. Importantly the outer plastic sheet fitted over the subframe 113 upon the exposed tear strips 102 can be curled upwardly to expose the clear window panes, with its bottom arranged and tucked inwardly beneath the upper portion of the sheet, as seen in FIG. 10. This insures that water, for example, draining off the arrangement will be directed outwardly.

After the external wall, such as brick exterior 121 has been completed, and construction is finished, brick portions of the exterior will normally not overlie the panels 109, or 110. At this point the covering sheet can be pulled away, and the subframe can simply be peeled away also. When and if portions 109, 110 of the subframe are covered by exterior bricks etc., the plastic sheet may be torn away and discarded, and the subframe 13 may be removed by cutting as before (i.e., with a knife as in FIG. 11). Portions of panel sides 92 will remain sandwiched and concealed within the wall structure, but they will not be visible.

From the foregoing, it will be seen that this invention is one well adapted to obtain all the ends and objects herein set forth, together with other advantages that are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A method for shrouding and temporarily protecting a prefabricated window from dirt, dust, debris, grime, over spray or the like during a construction process, the method comprising the steps of:
providing a source of elongated, resilient material comprising a planar body portion, an integral, planar foot portion, at least one adhesive peel strip disposed beneath the foot portion and at least one adhesive peel strip disposed atop said body portion;
providing a plurality of panels from said source of material of lengths corresponding to the length of the periphery of the window to be covered;
removing a tear strip from said at least one adhesive peel strip from said foot portions of said panels and adhesively affixing them to the periphery of said window, thereby forming a shroud subframe;
removing a tear strip from exposed tops of the panels to expose an adhesive patch about the outer periphery of said subframe;
affixing a sheet to said subframe upon the exposed adhesive patch to cover said window;
completing the installation of said window by performing additional construction steps and installing additional construction items proximate and/or adjacent said window; and,
when construction is completed, removing the sheet and subframe, thereby revealing and exposing a clean and unmarred window.

2. The method as defined in claim 1 wherein said step of completing the installation of said window by performing additional construction steps and installing additional construction items proximate and/or adjacent said window comprises the steps of:
permanently sandwiching the foot portions of the panels between said window and said additional construction items; and,
after construction is completed, cutting away the subframe.

3. The method as defined in claim 2 wherein said step of providing a source of material includes the step of providing said material with an integral ramp portion connecting said body and said foot portions, to offset said body portion from said foot portion to make it easier to open the window for ventilation.

4. The method as defined in claim 3 including the step of making the thickness of said body portion greater than the thickness of said foot portion.

5. The method as defined in claim 2 wherein:
said step of providing a sheet employs plastic selected from the group consisting of polyethylene, polypropylene, and polymer plastics; and,
said step of providing stock shrouding material employs plastic selected from the group consisting of polyethylene, polypropylene, and polymer plastics.

6. The method as defined in claim 2 wherein said step of providing a source of material includes the step of providing said material foot portion with a downwardly turned lip at its edge to contact an edge of said window for aligning said shroud subframe.

7. The method as defined in claim 1 wherein said step of providing a source of material includes the step of providing lips at both outer edged to reinforce the subframe.

8. A method for installing a prefabricated window, the method comprising the steps of:
providing a prefabricated window for installation, the window having a periphery;
providing a cage in which said window is to be mounted;
mounting and securing said window in said cage;
shrouding said window within said subframe to protected it from dirt, debris and grime during subsequent construction steps, said shrouding step comprising the steps of:
providing a plurality of elongated, resilient extrusions comprising an elongated, planar body portion, an integral, elongated, planar foot portion, at least one adhesive peel strip disposed beneath the foot portion and at least one adhesive peel strip disposed atop said body portion;
cutting or adjusting a plurality of extrusions of lengths corresponding to the length of the periphery of the window to be covered;
removing a tear strip from said at least one adhesive peel strip from said foot portions of said extrusions and adhesively affixing them to the periphery of said window to form a subframe;
removing a tear strip from said at least one adhesive peel strip from said body portions of said subframe to expose an adhesive patch about the outer periphery of said subframe;
affixing a sheet to said subframe upon the exposed adhesive patch to cover said construction window;
completing the installation of said window by performing additional construction steps and installing drywall proximate and/or adjacent said window, wherein the foot portions of the subframe extrusions are permanently sandwiched between said window and said drywall; and,
when construction is completed, removing said sheet and cutting away the subframe and, thereby revealing and exposing a clean and unmarred window.

9. The method as defined in claim 8 including the step of providing said extrusions with an integral ramp portion connecting said body and said foot portions, to offset said body portion from said foot portion to facilitate temporary opening of the window for ventilation.

10. The method as defined in claim 9 including the step of making the thickness of said body portion greater than the thickness of said foot portion.

11. The method as defined in claim 8 wherein said step of providing said sheet employs plastic selected from the group consisting of polyethylene, polypropylene, and polymer plastics.

12. The method as defined in claim 8 wherein said step of providing stock shrouding material employs plastic selected from the group consisting of polyethylene, polypropylene, and polymer plastics.

13. The method as defined in claim 8 wherein said step of providing said extrusions includes the step of providing said foot portion with a downwardly turned lip at its edge to contact an edge of said window for aligning said shroud subframe.

14. The method as defined in claim 13 wherein said step of providing extrusions includes the step of providing said body portion with an upwardly turned lip at its edge to contact shroud subframe parts that may overlie it.

15. A temporary shroud for protecting windows during construction, the windows comprising a periphery, the shroud comprising:
a plurality of elongated, resilient panels adapted to be cut and fitted to form a subframe about said window periphery, each panel comprising:
an elongated, planar body portion to be spaced apart over said window;
an integral, elongated, planar foot portion adapted to be attached to the window and sandwiched between the window and construction materials installed adjacent and proximate said window;
at least one adhesive peel strip disposed beneath the foot portion comprising an adhesive patch and a peel strip normally covering the patch that can be removed to secure the panel to the window;
another adhesive peel strip disposed atop the panel comprising an adhesive patch and a peel strip normally covering the patch that can be removed to expose the patch; and,
a sheet for covering said window secured to said panel body portions by the exposed adhesive patch.

16. The shroud as defined in claim 15 wherein each panel comprises an integral ramp portion connecting said body portions and said foot portions, to offset said body portion from said foot portion.

17. The shroud as defined in claim 15 wherein the thickness of said body portion is greater than the thickness of said foot portion.

18. The shroud as defined in claim 15 wherein said sheet is made from plastic selected from the group consisting of polyethylene, polypropylene, and polymer plastics.

19. The shroud as defined in claim 15 wherein said panels comprise plastic selected from the group consisting of polyethylene, polypropylene, and polymer plastics.

20. The shroud as defined in claim 15 wherein said foot portion comprises a downwardly turned lip at its edge to contact an edge of said window for aligning said subframe.

21. The shroud as defined in claim 20 wherein said body portion comprises an upwardly turned lip at its edge to contact shroud subframe parts that may overlie it.

22. A kit for shrouding prefabricated windows during construction, the windows comprising a periphery, and the kit comprising:
a plurality of elongated, resilient extrusions adapted to be cut and fitted to form a subframe about said window periphery, each extrusion comprising:
an elongated, planar body portion to be spaced apart over said window;
an integral, elongated, planar foot portion adapted to be attached to the window and sandwiched between the window and construction materials installed adjacent and proximate said window;
at least one adhesive peel strip disposed beneath the foot portion comprising an adhesive patch and a peel strip normally covering the patch that can be removed to secure the panel to the window;
at least one adhesive peel strip disposed atop the body portion comprising an adhesive patch and a peel strip normally covering the patch that can be removed to expose the patch; and,
a source of sheet materials providing sheet cut to an appropriate length for covering said window, said sheet secured to said subframe upon the exposed adhesive patch.

23. The kit as defined in claim 22 wherein each extrusion comprises an integral ramp portion connecting said body portions and said foot portions, to offset said body portion from said foot portion.

24. The kit as defined in claim 22 wherein the thickness of said body portion is greater than the thickness of said foot portion.

25. The kit as defined in claim 22 wherein said sheet is made from plastic selected from the group consisting of polyethylene, polypropylene, and polymer plastics.

26. The kit as defined in claim 22 wherein said extrusions are made from plastic selected from the group consisting of polyethylene, polypropylene, and polymer plastics.

27. The kit as defined in claim 22 wherein said foot portion comprises a downwardly turned lip at its edge to contact an edge of said window for aligning said subframe.

28. The kit as defined in claim 22 wherein said body portion comprises an upwardly turned lip at its edge to contact shroud subframe parts that may overlie it.
